(19) United States
(12) Patent Application Publication
(10) Pub. No.: US 2008/0148792 A1
(43) Pub. Date: Jun. 26, 2008

(54) AUTOMOBILE STEERING WHEEL AND BRAKE PEDAL LOCKING DEVICE

(76) Inventor: Ross Davis, Palmyra, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/955,139

(22) Filed: Dec. 12, 2007

Related U.S. Application Data
(60) Provisional application No. 60/874,599, filed on Dec. 12, 2006.

(51) Int. Cl. B60R 25/02

(52) U.S. Cl. 70/238

(57) ABSTRACT

An anti-theft device for automobiles is disclosed. Generally the device includes an elongated rod extending between the steering wheel and the shaft of a brake pedal of an automobile; an L-shaped member extends from the rod and abuts the underside of the brake pedal; a lower tubular structure that can be slid over the rod; a second L-shaped member extending from the lower tubular structure that contacts the first L-shaped member and creates a passageway having a substantially enclosed perimeter in which the shaft of the brake pedal is located; an upper tubular structure that can be slid over the rod; a third L-shaped member extends from the upper tubular structure and attaches to the steering wheel; and means for locking the device that prohibits substantial movement of the upper tubular structure.

### CROSS-REFERENCE TO RELATED APPLICATION

The present application claims the benefit of U.S. Provisional Application Ser. No. 60/874,599 filed on Dec. 12, 2006, the entirety of which is hereby incorporated by reference.

### FIELD OF THE INVENTION

The present invention relates generally to automobile anti-theft devices. More specifically, the present invention relates to an automobile brake and steering wheel locking device.

### BACKGROUND OF THE INVENTION

Automobile anti-theft devices are known in the prior art. U.S. Pat. Nos. 5,005,391; 5,671,620; 5,704,233; 6,439,005 and 6,439,013 each disclose automotive anti-theft devices that engage the brake or gas pedal shafts and the steering wheel and/or the steering wheel spokes as a means for preventing theft of the vehicle.

While these devices fulfill their respective objectives and requirements, these prior art devices all suffer from various deficiencies. For example, such devices are complicated to use and expensive to manufacture.

### SUMMARY OF THE INVENTION

It is therefore an object of the present invention to provide a vehicle anti-theft device which mechanically immobilizes the brake pedal and the steering wheel by hooking them both with a locking device.

Another object of the present invention is to provide a vehicle anti-theft device that is light-weight, easy to assemble and durable.

Another object of the present invention to provide an anti-theft device for vehicles which is adaptable to fit various models of vehicles.

A still further object of the present invention is to provide an anti-theft device for vehicles which when locked in position renders the vehicle steering wheel and brake pedal inoperative.

Another object of the present invention is to provide an anti-theft device for vehicles which when locked in position renders it difficult to enter the vehicle.

A still further object of the present invention is to provide a vehicle anti-theft device which is locked into position by a user supplied lock.

These and other objects are met by the present invention which in one aspect can be an anti-theft apparatus for securing a vehicle comprising: a rod extending along an axis from a proximal end to a distal end; a first member connected to the rod at or near the distal end, the first member diverging from the axis of the rod and extending toward the proximal end; a first tubular member having a first end, a second end, and a cavity, a second member connected to and extending from the first tubular member; the first tubular member slid over the rod so that the rod extends through the cavity of the first tubular member, the first tubular member located on the rod so that the first member contacts the second member so as to form a passageway having a substantially enclosed perimeter; a second tubular member having a first end, a second end and a cavity, the second tubular member slid over the rod so that the rod extends through the cavity of the second tubular member; a third member connected to the second tubular member, the third member diverging from the axis of the rod and extending toward either the distal end or the proximal end of the rod; and means for locking that prohibits substantial movement of the second tubular member along the axis of the rod.

In another aspect the invention can be an anti-theft apparatus for use with an automobile having a steering wheel and a shaft for a pedal, the anti-theft apparatus comprising: a rod extending along an axis from a proximal end to a distal end, the proximal end of the rod extending beyond the steering wheel and the distal end of the rod extending beyond the shaft when the apparatus is installed in the automobile; a first member connected to the rod at or near the distal end, the first member diverging from the axis of the rod and extending toward the proximal end, the first member positioned about the shaft of the pedal when the apparatus is installed in the automobile; a first tubular member having a first end, a second end, and a cavity, a second member connected to and extending from the first tubular member; the first tubular member slid over the rod so that the rod extends through the cavity of the first tubular member, the first tubular member located on the rod so that the first member contacts the second member so as to form a passageway having a substantially enclosed perimeter, the shaft of the pedal extending through the passageway when the apparatus is installed in the automobile; a second tubular member having a first end, a second end and a cavity, the second tubular member slid over the rod so that the rod extends through the cavity of the second tubular member; a third member connected to the second tubular member, the third member diverging from the axis of the rod and extending toward either the distal end or the proximal end of the rod, the third member positioned about the steering wheel when the apparatus is installed in a vehicle; and means for locking that prohibits substantial movement of the second tubular member along the axis of the rod.

### BRIEF DESCRIPTION OF THE DRAWINGS

FIG. 1 is a perspective view of a vehicle steering wheel and brake pedal locking device according to one embodiment of the present invention.

FIG. 2 is an exploded perspective view of a vehicle steering wheel and brake pedal locking device according to one embodiment of the present invention.

FIG. 3 is a perspective view of the vehicle locking device of FIG. 1 engaging and locking the steering wheel and brake of an automobile together according to one embodiment of the present invention.

### DETAILED DESCRIPTION

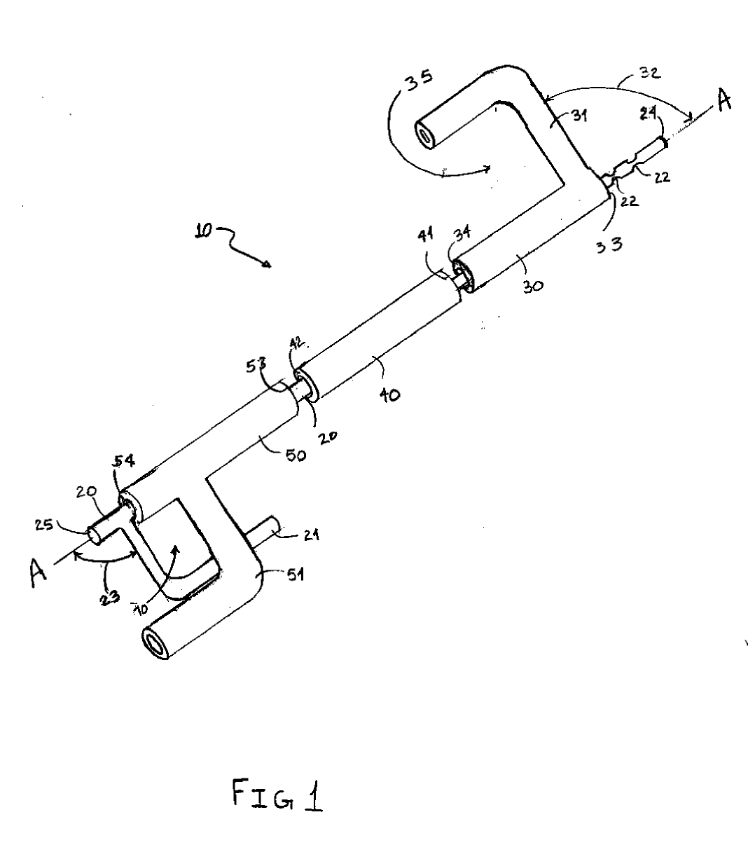

Referring to FIG. 1, an anti-theft device 10 is shown according to one embodiment of the present invention. As will be described below, anti-theft device 10 may be used to hook and immobilize the steering wheel and brake pedal of a vehicle to prevent theft.

Device 10 comprises an elongated cylindrical body 20, a first/lower sleeve 50, a second/upper sleeve 30 and a third/middle sleeve 40. As will be discussed in more detail below, sleeves 30, 40, 50 are hollow tubular structures, that can circumferentially surround body 20.

Body 20 is a solid cylindrical rod structure comprising an upper end 24 and a lower end 25. The invention is not so limited, however, and body 20 could be a rectangular, square, or other shaped rod or bar. The body 20 further comprises a major axis A-A extending from the upper end 24 to the lower end 25. The upper end 24 may also be considered a proximal end and the lower end 25 may be considered a distal end. Cylindrical body 20 is preferably constructed of steel and/or alloy or other suitable material that cannot be easily cut bent, broken or otherwise deformed.

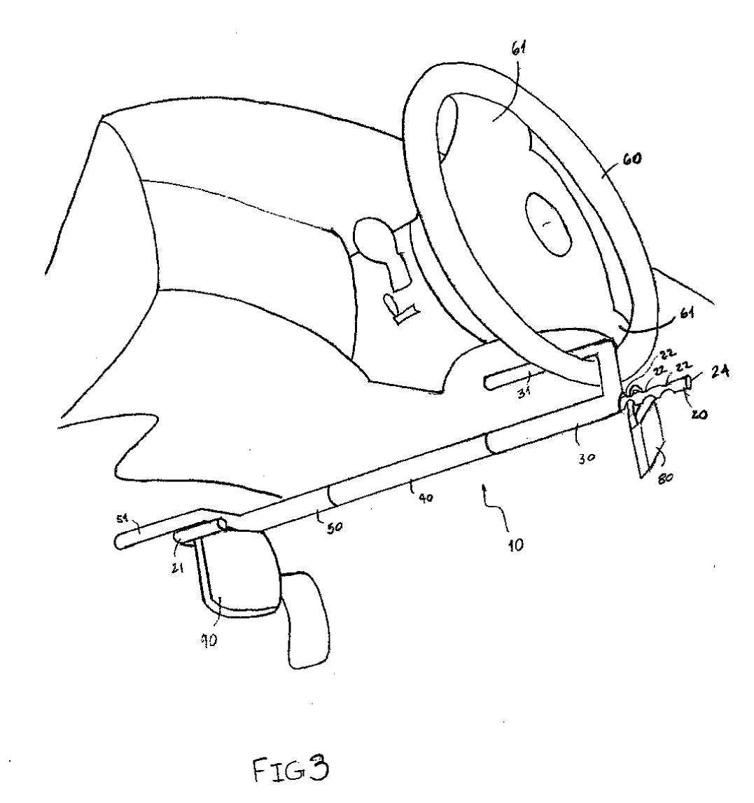

A first hook member 21 diverges from the body 20 and is connected to the body 20 at or near its lower end 25. As will be described in greater detail below, the first hook member 21 abuts the under side of a shaft of a brake pedal of a vehicle (FIG. 3). The first hook member 21 is generally L-shaped and diverges from the major axis A-A of the body 20. The divergence is represented by numerical identifier 23, and in the preferred embodiment is 90 degrees. The invention is not so limited, and the angle of divergence can vary so long as hook member 21 can abut the shaft of a vehicle. Hook member 21 additional extends in an upward direction, i.e. towards the upper end 24 of body 20.

Body 20 further comprises a plurality of spaced apart transverse holes 22 at or near its upper end 24. Holes 22 are of sufficient diameter to receive the hasp of a padlock or other user supplied lock 80 (FIG. 3). As will be discussed in more detail below, the holes 22 provide means for receiving a lock that prohibits substantial movement of the upper sleeve 30 when the device 10 is installed in a vehicle.

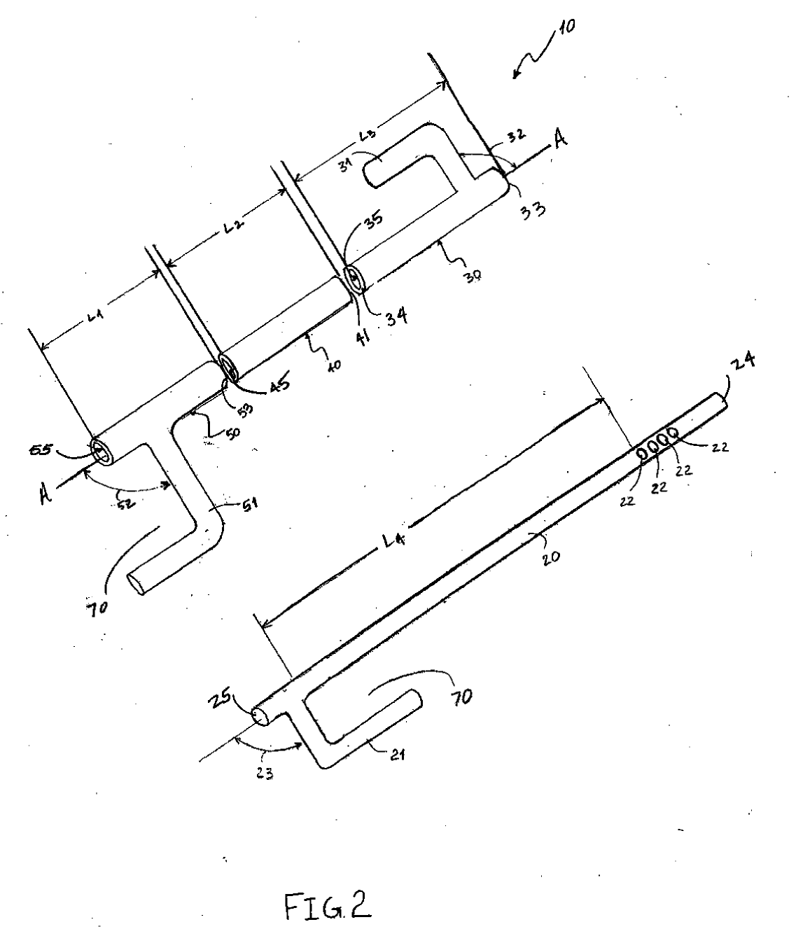

The lower sleeve 50 is a hollow tubular structure that circumferentially surrounds the body 20. Lower sleeve 50 comprises a cavity 55 (seen in FIG. 2.), an upper end 53 and a lower end 54. The lower sleeve 50 slides over the body 20 so that the body 20 extends through the cavity 55. A portion of the body 20 protrudes beyond the upper end 53 of the lower sleeve 50.

A second hook member 51 is connected to the lower sleeve 50 at or near its lower end 54. The second hook member 51 is generally L-shaped and diverges from the axis A-A of the body 20 when the sleeve 50 is positioned on the body 20. The divergence is represented by numerical identifier 53, and in the preferred embodiment is an angle of 90 degrees. The invention is not so limited, and the angle of divergence can vary. The second hook member 51 extends in a downward direction, i.e. towards the lower end 25 of body 20. The sleeve 50 slides over the body 20 until the lower end 54 contacts the first hook member 21. The lower end 54 may be in surface contact with the hook member 21, but the invention is not so limited. The first hook member 21 contacts the second hook member 51 so as to form a passageway 70 that has a substantially enclosed perimeter. The sleeve 50 is preferably constructed of steel and/or alloy or other suitable material that cannot be easily cut, bent, broken or otherwise deformed. As will be discussed in greater detail below, the passageway 70 provides an opening through which a shaft of a brake pedal can fit.

The middle sleeve 40 is a hollow tubular structure that can slide over the body 20 and circumferentially surround body 20. The diameter of the middle sleeve 40 is equal to the diameter of the lower sleeve 30. The invention is not so limited, however, so long as the middle sleeve 40 and the lower sleeve 50 do not significantly overlap. Middle sleeve 40 comprises a cavity 45 (seen in FIG. 2.), an upper end 41 and a lower end 42. The middle sleeve 40 slides over body 20 and is positioned between the upper sleeve 30 and the lower sleeve 50. The body 20 extends through the cavity 45 and a section of the body 20 protrudes beyond the upper end 41 of the middle sleeve 40. The lower end 42 of the middle sleeve 40 may be in surface contact with upper end 53 of the lower sleeve 50. Alternatively, the middle sleeve 40 could be fused with either the upper sleeve 30 or the lower sleeve 50 so that one continuous part is formed, resulting in only two sleeves, a lower sleeve and an upper sleeve. Middle sleeve 40 is preferably made of steel and/or alloy or other suitable material that cannot be easily cut, bent, broken or otherwise deformed. In another embodiment the length of upper sleeve 30 or lower sleeve 50 may be greater so that there is no need for middle sleeve 40.

Upper sleeve 30 is a hollow tubular structure that circumferentially surrounds sleeve 20. Upper sleeve 30 comprises a cavity 35 (seen in FIG. 2.), a lower end 34 and an upper end 33. A third hook member 31 is connected to the upper sleeve 30 at or near its upper end 33. The third hook member 31 is generally L-shaped and diverges from the axis A-A of the body 20. The divergence is represented by numerical identifier 32, and in the preferred embodiment is 90 degrees. The invention is not so limited, and the angle of divergence can vary. The third hook member 31 forms a second passageway 35 that is generally U-shaped and designed to grasp a steering wheel. The second passageway 35 is illustrated as oriented downward. Downward means facing the lower end 25 of body 20. The invention is not so limited, and cavity 35 could be in an upward direction. Upward being defined as facing toward the top end 24 of body 20. The lower sleeve 30 is positioned over the body 20 so that the third hook member 31 abuts a steering wheel 60 of a vehicle (FIG. 3). The lower end 34 of the upper sleeve 30 may be in surface contact with the upper end 41 of middle sleeve 40. The diameter of lower end 34 of upper sleeve 30 is relative to the diameter of upper end 41 of middle sleeve 40 in such that, when assembled on body 20 middle sleeve 40 cannot be removed from body 20 without first removing upper sleeve 30. Upper sleeve 30 is preferably constructed of steel and/or alloy or other suitable material that cannot be easily cut, bent, broken or otherwise deformed.

Referring now to FIG. 2, an exploded view of anti-theft device 10 is illustrated according to one embodiment of the present invention. The body 20 has a length consistent with the distance between the steering wheel 60 and the brake pedal 90 of a motor vehicle (FIG. 3). Sleeves 30, 40, 50 are hollow so that they can slidably engage with body 20. The diameter of the body 20 is less than the inner diameter of the sleeves 30, 40, 50. The upper sleeve 30 has a length L₃. The middle sleeve 40 has a length L₂. The lower sleeve 50 has a length L₁. The combined length of the sleeves 30, 40, 50 is the sum of L₁, L₂ and L₃. The combined length of the sleeves 30, 40, 50 is less than the length L₄ of the body 20 so that when sleeves 30, 40, 50 are slidably coupled with the body 20, the holes 22 remain exposed. The holes 22 provide means for attaching a user supplied lock 80 at various lengths so that the device 10 can be used in different vehicles wherein the length between a brake pedal and a steering wheel varies according to vehicle type. The invention is not limited to holes 22, other means for locking the device 10 may be used including clamps, key lock mechanisms, combination locks and other locling mechanisms. Additionally, the holes 22 could extend through both the upper sleeve 30 and the body 20 so that the upper sleeve 30 is locked into place.

Referring now to FIG. 3, when installed in a vehicle, the first hook member 21 is positioned about a shaft of the brake pedal 90 (or accelerator pedal) and the upper end 24 of the body 20 extends beyond the steering wheel 60. The upper end 24 of the body 20 can run under the steering wheel 60 (as illustrated) or can extend through the steering wheel 60 in between the steering wheel's spokes 61. The second hook member 51 engages over top of the shaft of brake pedal 90 while the first hook member 21 grasps underneath the shaft of brake pedal 90. The upper sleeve 30 engages the steering wheel 60 via the third hook member 31. A lock 80 is inserted in one of holes 22 to secure the upper sleeve 30 in place. When the device 10 is locked into position, as described in more detail below, the brake pedal 90 is immobilized by the second hook member 51 and the first hook member 21. The middle sleeve 40 prevents the lower sleeve 50 from rising in order that the second hook member 51 cannot be removed from around the shaft of brake pedal 90 without first removing the middle sleeve 40. The upper sleeve 30 likewise prevents the removal of the middle sleeve 40 from the body 20. The lock 80 prevents the removal of the upper sleeve 30 from body 20.

In use, the user, before exiting the automobile, will separate the sleeves 30, 40, 50 from the body 20 by sliding the sleeves 30, 40, 50 along the body 20 in an upward direction until they no longer surround body 20. The user will hook the second hook member 21 around the bottom of the brake pedal shaft, pulling the body 20 in an upward direction, and aligning the upper end 24 of the body 20 with the bottom of steering wheel 60. The upper end 24 of the body 20 may either be aligned underneath the bottom of the steering wheel 60, as illustrated, or run through the bottom part of the steering wheel 60 between the spokes 61. The lower sleeve 50 may then be slid down the body 20 and positioned so that the first hook member 51 surrounds the top of the shaft of brake pedal 90. The middle sleeve 40 may then be slid down over the upper end 24 of the body 20 and positioned so that the lower end 42 of the middle sleeve 40 is in contact with the upper end 53 of the lower sleeve 50. The upper sleeve 30 may then be slid down over the body 20 and positioned so that the third hook member 31 abuts with the steering wheel rim 60. A lower end 34 of the upper sleeve 30 may be in contact with an upper end 41 of the middle sleeve 40, however this depends on the length between the steering wheel 60 and the brake pedal 90. If the length between the steering wheel 60 and the brake pedal 90 is greater than the combined length L₁, L₂, L₃ of sleeves 30, 40, 50 (FIG. 2) then there will be gaps between the sleeves. The user supplied lock 80 is inserted through the hole 22, in the upper end 24 of the body 20, that is closest to the upper end 33 of the upper sleeve 30. Once the lock 80 is secured the relative movement of components 30, 40, 50 is minimized, thereby immobilizing the steering wheel 60 and brake pedal 90. The device 10 cannot be removed without first opening the lock 80 and then slidably removing sleeves 30, 40, 50 from body 20.

While the invention has been described and illustrated in sufficient detail that those skilled in this art can readily make and use it, various alternatives, modifications, and improvements should become readily apparent without departing from the spirit and scope of the invention.

What is claimed is:

1. An anti-theft apparatus for securing a vehicle comprising:
a rod extending along an axis from a proximal end to a distal end;
a first member connected to the rod at or near the distal end, the first member diverging from the axis of the rod and extending toward the proximal end;
a first tubular member having a first end, a second end, and a cavity;
a second member connected to and extending from the first tubular member;
the first tubular member slid over the rod so that the rod extends through the cavity of the first tubular member, the first tubular member located on the rod so that the first member contacts the second member so as to form a passageway having a substantially enclosed perimeter;
a second tubular member having a first end, a second end and a cavity, the second tubular member slid over the rod so that the rod extends through the cavity of the second tubular member;
a third member connected to the second tubular member, the third member diverging from the axis of the rod and extending toward either the distal end or the proximal end of the rod; and
means for locking that prohibits substantial movement of the second tubular member along the axis of the rod.

2. The apparatus of claim 1 wherein the rod has a length greater than a combined length of the first tubular member and the second tubular member.

3. The apparatus of claim 1 wherein the first and second tubular members are adjacent one another along the axis of the rod.

4. The apparatus of claim 1 wherein the rod is a solid cylindrical rod.

5. The apparatus of claim 1 further comprising a third tubular member slid over the rod and located between the first tubular member and the second tubular member.

6. The apparatus of claim 1 wherein the first member, the second member and the third member are L-shaped.

7. The apparatus of claim 1 wherein the second member extends beyond the distal end of the rod.

8. The apparatus of claim 1 wherein the rod, the first tubular member, the second tubular member and the third tubular member are made of metal.

9. The apparatus of claim 1 further comprising at least one hole located at or near the proximal end of the rod for receiving the locking means.

10. An anti-theft apparatus for use with an automobile having a steering wheel and a shaft for a pedal, the anti-theft apparatus comprising:
a rod extending along an axis from a proximal end to a distal end, the proximal end of the rod extending beyond the steering wheel and the distal end of the rod extending beyond the shaft when the apparatus is installed in the automobile;
a first member connected to the rod at or near the distal end, the first member diverging from the axis of the rod and extending toward the proximal end, the first member positioned about the shaft of the pedal when the apparatus is installed in the automobile;
a first tubular member having a first end, a second end, and a cavity;
a second member connected to and extending from the first tubular member;
the first tubular member slid over the rod so that the rod extends through the cavity of the first tubular member, the first tubular member located on the rod so that the first member contacts the second member so as to form a passageway having a substantially enclosed perimeter, the shaft of the pedal extending through the passageway when the apparatus is installed in the automobile;
a second tubular member having a first end, a second end and a cavity, the second tubular member slid over the rod so that the rod extends through the cavity of the second tubular member;
a third member connected to the second tubular member, the third member diverging from the axis of the rod and extending toward either the distal end or the proximal end of the rod, the third member positioned about the steering wheel when the apparatus is installed in a vehicle; and
means for locking that prohibits substantial movement of the second tubular member along the axis of the rod.

11. The apparatus of claim 10 wherein the rod has a length greater than a combined length of the first tubular member and the second tubular member.

12. The apparatus of claim 10 wherein the first and second tubular members are adjacent one another along the axis of the rod.

13. The apparatus of claim 10 wherein the rod is a solid cylindrical rod.

14. The apparatus of claim 10 further comprising a third tubular member slid over the rod and located between the first tubular member and the second tubular member.

15. The apparatus of claim 10 wherein the first member, the second member and the third member are L-shaped.

16. The apparatus of claim 10 wherein the second member extends beyond the distal end of the rod.

17. The apparatus of claim 10 wherein the rod, the first tubular member, the second tubular member and the third tubular member are made of metal.

18. The apparatus of claim 10 further comprising at least one hole located at or near the proximal end of the rod for receiving the locking means.
